(19) United States
(12) Patent Application Publication
(10) Pub. No.: US 2021/0363775 A1
(43) Pub. Date: Nov. 25, 2021

(54) FOOTING SYSTEM

(71) Applicant: Goodcart Pty Ltd, Mona Vale (AU)

(72) Inventor: Douglas Rawson-Harris, Mona Vale (AU)

(21) Appl. No.: 16/975,103

(22) PCT Filed: Feb. 22, 2019
(86) PCT No.: PCT/AU2019/050149

§ 371 Date: Aug. 21, 2020

(30) Foreign Application Priority Data
Feb. 23, 2018 (AU) 2018900583

(51) Int. Cl. E04H 12/22; E02D 27/42

(52) U.S. Cl. CPC E04H 12/2261; E02D 27/42; E04H 12/2238

(57) ABSTRACT

A method, system and support element for supporting a pole, mast or similar elongated element to a foundation. The pole, mast or similar elongated element comprises a wall which is substantially continuous. A plurality of discontinuities, such as eg. channels or recesses, are provided about the periphery of the pole. A plurality of the support members are positioned on the pole and adapted to extend between the pole and the foundation thereby transmitting force from the pole to the foundation. Each support member is adapted to extend between at least two of the discontinuities and engage the discontinuities over a predetermined axial length of the pole.

### TECHNICAL FIELD

The present invention relates to system and method for anchoring a post or pole to the ground and particularly but not only for anchoring an aluminium pole into a concrete pier, foundation or the like.

### BACKGROUND

In the field of elongated support structures and in particular street poles or lighting, there have been significant changes made in the manufacture and instalment of such street and outdoor lighting poles.

Previously, support structures for street lighting etc. were constructed from timber or as a unitary steel tubular body. Architectural design and aesthetic demand has led to the development of a wide range of options for such street lighting.

With urban designers requiring the need for pole mounted lighting, traffic control, CCTV, banners, signage, public warning, communication, environmental monitoring, pedestrian management and many other applications in public areas it was inevitable that a streetscape would become cluttered with a myriad of different poles delivering these services. Not only has this become visually unsatisfactory in many places but also it has created a maze of obstructions in pedestrian areas using up valuable civic space.

This has a new generation of light poles that delivers to the community an effective solution to the growing number of single purpose poles that are sprouting in the urban environment.

In particular the applicant has developed its Multipole™ and Multipole Solar™ products that deliver an aesthetically pleasing all aluminium multi-function pole that can provide a flexible secure home for many of the services required in the streetscape. In addition the poles can be the basis for the provision of public amenities such as bike racks, bus shelters, water bubblers and seats.

Early generations of these poles relied on a steel core clad in aluminium decorative cladding however recent developments have removed any reliance on steel by designing a pole based on the Applicant's own extrusion technology.

This provides a number of significant advantages including improved sustainability since aluminium poles have a smaller carbon footprint, reduce installation costs as the weight of aluminium poles is substantially less than steel poles and the composite arrangement of producing the pole in separate connectable tubes reduce transport costs, low maintenance costs and resistance to graffiti, a safer pole due to its inherent energy absorbing nature of aluminium as compared with steel, excellent strength and ability to withstand severe environmental conditions, aesthetic advantages since there are no welded joints in the extruded aluminium pole section (such welded joints also provide a weakness in conventional steel poles) as well as the ability to produce tracks or channels in the aluminium extrusion to allow installation of accessories at various heights over the pole.

In addition, as mentioned above, the aesthetics of street lighting and other support poles has become an important design criteria. Many recent designs will have their aesthetic value diminished by an unsightly connection arrangement between the upper and lower poles.

Particular difficulties are involved with mounting or installing aluminium poles. Firstly, aluminium does not weld easily. Accordingly, welding the aluminium pole to a foundation plate or similar is difficult and in some cases can weaken the poles. Further, connecting the pole to a steel plate or the like, using a steel sleeve to support the pole, etc. is not ideal since it adds cost both in materials and installation. It may also give rise to corrosion. For instance, galvanic corrosion occurs where steel and aluminium are in contact. This is particularly true of the lower portions of the pole which are often wet, leading to the ideal conditions for corrosion of various types such as galvanic corrosion, pitting or crevice corrosion.

It is an object of the present invention to overcome or ameliorate at least one of the disadvantages of the prior art, or to provide a useful alternative.

### DISCLOSURE OF THE INVENTION

In a first broad aspect, the present invention provides a system for connecting a pole, mast or similar elongated element to a foundation, said pole, mast or similar elongated element having an exterior wall with a plurality of discontinuities disposed about its periphery, said system comprising of plurality of support members adapted to extend between the pole and the foundation, said support members adapted to extend between at least two of said discontinuities and engage said discontinuities over a predetermined axial length.

In a second aspect, the present invention provides a support element for supporting a pole, a mast or similar elongated element to a foundation, said elongated element having an exterior wall with a plurality of discontinuities disposed about its periphery, said support member having a first engagement portion adapted to span between at least two of said discontinuities and engage said discontinuities over a predetermined axial length, and a second foundation portion outwardly extending from the first portion for fixing to a foundation.

In a third aspect, the present invention provides a method of supporting a pole, mast or similar elongated element to a foundation, said pole, mast or similar elongated element having an exterior wall with a plurality of discontinuities disposed about its periphery, said method comprising providing a plurality of support members extending between the pole and the foundation, said support member extending between at least two of said discontinuities and positioned to engage said discontinuities over a predetermined axial length to thereby support said pole and transmit force applied to the pole through the said foundation.

The present invention provides a unique approach to mounting an elongated element on a foundation. Typically the foundation would be a plinth, concrete base or similar. The present discussion will be with reference to a typical pole or mast constructed from extruded aluminium. However, it would be understood that the present invention may be applied to any elongated member with the aforementioned discontinuities thereon.

The present invention will also now be described with reference to a typical hollow pole, mast or similar. However, it will be understood by persons skilled in the art that the present invention also has application to a solid elongated element such as a rod or similar, also with the beforementioned discontinuities thereon.

Typically, a pole, mast or similar will be constructed with an exterior wall of any desired cross sectional shape. It is typically circular due to the structural integrity of such a shape. Discontinuities can be formed in or applied to the wall of the elongated element for various reasons. These include aesthetic or structural reasons. Recesses or channels can also be formed in the pole for attachment at various accessories and the like.

The present invention involves the provision of plurality of support members which extend between the pole and the foundation. The support members also extend between at least a pair of discontinuities over a predetermined axial length.

The support member preferably comprises two functional portions. The first portion is adapted to slidably engage and be retained by the pole. The second portion extending outwardly therefrom is adapted for fixing to the foundation. All loads applied to the pole/mast are then passed directly into foundation via the support members. Preferably, the support member has an elongated portion or portions which is slidably engage with discontinuities on the pole over a predetermined length and retained by the pole. The length of this contact will depend upon the likely forces applied by the pole to the foundation.

To explain, it is desired that the forces applied to the pole which are then transmitted by the support member into the foundation, are spread over the largest possible area. This proves stability of the pole/mast and reduces the opportunity for concentration of stress in the pole of damage. Accordingly, the longer the predetermined length over which support member engages the pole, the greater the contact between the support member/element of the pole and the more effective the compensation or distribution of forces applied to the pole for transmission to the foundation member. The forces applied to the support member by the pole are affected by various matters including the size of the pole, its weight and construction, the likely forces to be applied to the pole eg, additional weights, accessories, signs attached to the pole, wind. Typically, the predetermined length of the contact/engagement of the support member with the pole or discontinuity would be around 200-500 millimetres in the axial direction preferably around 250-350 millimetres for a typical street light pole, traffic pole, etc.

By transmitting the force applied to the pole, through the aforementioned predetermined length of the support member into the foundation member, the possibility of damage or failure is substantially reduced. As mentioned above, most telegraph poles, mast, etc. are hollow and provided with a thin wall. While this wall is generally secure, it can in certain circumstances fail. Preferably, the discontinuities on the wall of the pole, mast or elongated element, are formed as structural stiffening ribs, channels or the like. These ribs, channels or similar are less susceptible to damage than the aforementioned thin wall of the pole, mast or the like. Further, these strengthening ribs can resist the force applied to the pole in a more effective fashion than say, a thin walled pole, etc.

Conventional system generally involved welding or bolting of a truss, bracket, or similar directly to the wall of the pole. The present invention overcomes at least some of the problems of conventional systems by providing a system and method for mounting a pole, mast or similar elongate element on a foundation in a more efficient and reliable way. The present invention compensates or dissipates the forces applied to the pole thereby preventing or at least reducing damage or failure of the pole in a cost effective and aesthetically pleasing manner.

That portion of the support member for engagement with the foundation is preferably adapted to be embedded, bolted or otherwise fixed to the foundation member. In this way, it can be seen that there is no need for additional fixing of the support member to the pole eg. bolting welding or the like.

In at least a preferred embodiment, it is proposed to provide a system for connecting a pole to a foundation or similar which is both safe and reliable and reduces the opportunity for the abovementioned corrosion.

As mentioned above, in a preferred embodiment, the pole is constructed from extruded aluminium. It is preferably formed with a plurality of channels or recesses adapted to slidably receive and retain the aforementioned support members.

In a preferred embodiment, the extruded aluminium pole is provided with a series of recesses or channels adapted for various functions eg. Mounting various accessories, signs etc on the pole in use. Multifunctional poles are quite common in most cities. The recesses and channels are provided in the poles for both functional and synthetic reasons. However, they can in fact can make mounting of the pole/mast more difficult than a conventional steel pole.

The present invention, on the other hand, utilises these channels/recesses in an inventive way which has substantial advantages. The support members/elements are preferably configured to slidably engage and be retained in these recesses or channels thereby removing any need for significant modification of the pole as well as providing safe, reliable and easy contact between the support members and the pole.

The inventive system is quite different from the prior art which generally requires mechanical fixing of the support members to the pole prior to the connection with the foundation. For instance, many support members are welded or bolted to the pole. This brings about significant weakness particularly in aluminium poles. Welding of aluminium is a difficult process. Typically, street signs, telegraph poles, etc, are produced from 6000 series aluminium. This gives excellent structural performance and corrosion resistance as well as anodising suitability. However, these alloys are not recommended for welding due to the potential loss of the original strength. Still further, bolting support members or brackets to the pole concentrates the stress in the area of the bolts thereby reducing its effectiveness.

The present invention provides a mechanism of reliably supporting a pole, mast or the like, in a substantially vertical configuration for instance, while avoiding some of the problems of the prior art.

The support members can be provided in a variety of shapes. At least one portion of the support member is preferably slidably engageable with the discontinuities of the pole over a predetermined length of the support member. Another portion of the support member is adapted for connection to the foundation. In this way, the support member acts to maintain the pole in a substantially vertical orientation by resisting any tipping forces applied to the pole.

In a particularly preferred embodiment, a plurality of support members are provided around the perimeter of the base of the pole. In one embodiment, the support member/elements can be of constant cross section in length. In another embodiment, the support members are substantially L shaped with a vertical portion adapted for slidably engagement with aluminium pole, and a base portion extending outwardly therefrom and adapted to be connected to foundation.

The system may also include foundation bolts which are embedded in the foundation eg, cast concrete, and can be connected to the aforementioned lower portion of the support bracket.

In a particularly preferred embodiment, the support members are produced from material other than the material of the pole/mast, for example a polymeric material. This embodiment allows them to provide structural support and easy engagement with the pole and foundation bolts, but avoids any galvanic or other corrosions associated with providing ferrous or non ferrous metal as the support members.

In another preferred embodiment, the support member is provided with at least a pair of arm portions adapted to be slidably engage a pair of preferably opposed discontinuities in the pole. In a particularly preferred embodiment, the arms can be biased to engage said discontinuities. Preferably the support members are adapted to engage a pair of opposed channels or recesses on the pole. The arms of the support bracket can be biased outwardly such that the arms are forced inwardly to position the support member between the recesses/channels, and upon release the arms engage the aforementioned opposing discontinuities or channels recesses.

This biasing of the support member can be accomplished by the structure of the support member itself or in a particularly preferred embodiment a camming arrangement can be provided which assists not only in positioning of the support member on the pole but operates to bias the arm portions into engagement with the channels or recesses on the pole.

### BRIEF DESCRIPTION OF THE DRAWINGS

The present invention will now be described with reference to the accompanying drawings in which;

FIG. 1 is perspective view of the support elements in accordance with the first embodiment of the present invention.

FIG. 2 is a perspective view of a plurality of support elements attached to a base portion of a pole in accordance with another embodiment of the present invention.

FIGS. 3 and 4 are cross sectional views of a support element and pole in accordance with another embodiment of the present invention.

FIGS. 5 and 6 are perspective and cross sectional view of the support element and pole connected to a foundation in accordance with yet another embodiment of the present invention.

FIG. 7 is a cross sectional view of yet another embodiment of the present invention.

### BEST MODE(S) FOR CARRYING OUT THE INVENTION

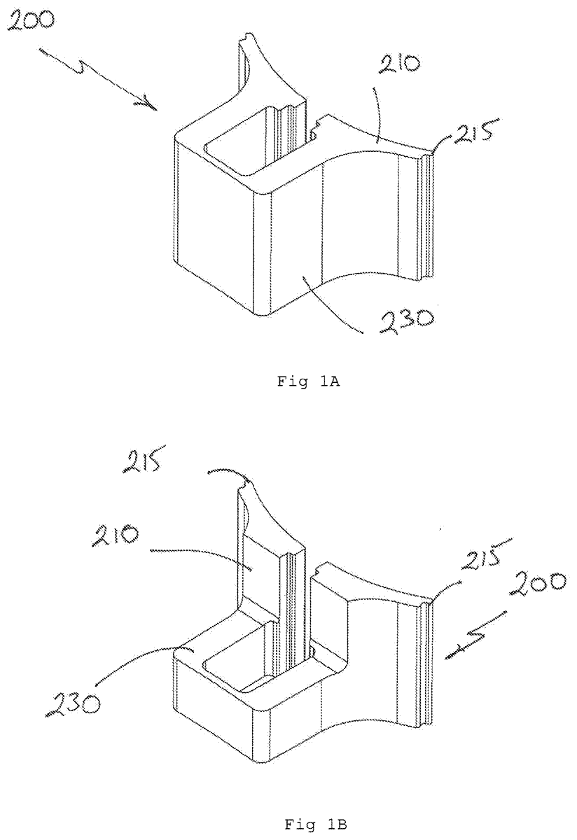

FIGS. 1A and 1B are is perspective views of a support members in accordance with preferred embodiments of the present invention.

The support member/element 200 is adapted to extend between at least a pair of discontinuities on the pole. These discontinuities preferably extend in the axial direction of the elongated pole or mast. In the following description, these discontinuities are provided by recesses/channel formed in the pole wall. It will be understood, however, such discontinuities can be provided in other forms eg. strengthening ribs.

The support element comprises two portions. The first portion is an engagement portion 210 for slidable engagement and retention by the pole as will be discussed below. In the embodiment shown, this engagement portion comprises a pair of arms terminating in engagement ribs 215. These engagement ribs 215 are sized to closely engage with the aforementioned discontinuities eg. recesses or channels on the pole.

The support member/element 200 further comprises an outwardly extending foundation portion 230 adapted for fixing to a foundation, wall or the like as will be discussed below. The support elements as shown in FIGS. 1A and 1B are intended to support a pole or other elongated element in a substantially vertical configuration. It will be understood by persons skilled in the art, however, the support elements could equally be configured to support the elongated members in other configurations.

As will be seen in FIG. 1A, the support element 200 shown is essentially constant in cross sectional shape. However, it is also possible to provide a support element in other configurations for example as shown in FIG. 1B with the engaging portion 210 and outwardly extending foundation portion 230 as a L-shape element or similar.

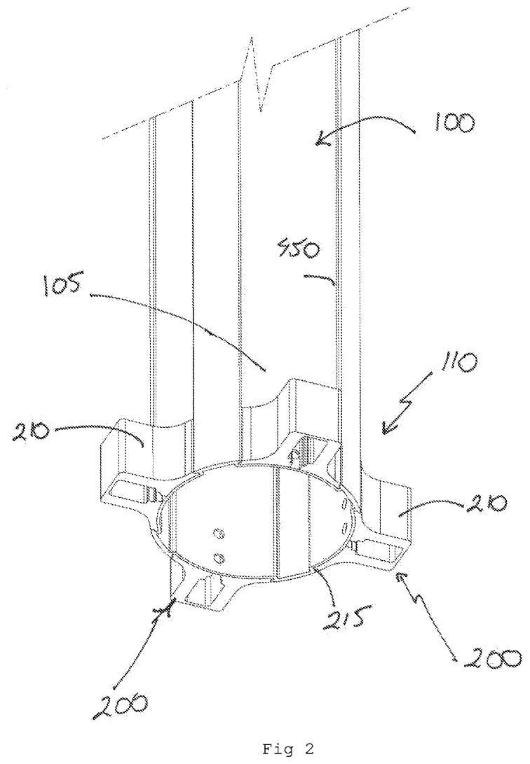

One of the significant advantages of the embodiment in which the support member is of constant cross section (FIG. 1A), is that it provides excellent flexibility and reliable mounting of the pole since the support member can be simply sized to match the expected loads on each support/element. As will be discussed below, for a typical traffic sign/telegraph pole, the predetermined length of the support member engaging this discontinuities ie. contacting the pole would be around 250 millimetres. For a larger, heavier pole it is expected that this contact length may in fact be around 350 millimetres but it is expected that most support members in the range of 200-500 millimetres would be able to support most commercially available traffic or telegraph poles. If, as it is proposed, the support element is of constant cross section, it can be simply cut to length and it is not necessary to individually prepare support elements for each pole. An operator could simply determine the required length of the support member, (load rating markings on the support member could assist) then cut the support member to length and engage the pole as shown in FIG. 2. As it will be discussed below, the operator can then connect the support element to the foundation.

Referring now to the embodiment of FIG. 2, this displays the base 110 of a pole such as a light pole, flag pole, telegraph pole, etc. The pole 100 comprises a wall 105 which is substantially circular in cross section. A plurality of discontinuities 150, in this case channels or recesses, extend in the longitudinal or axial direction on the wall 105. The term “discontinuities” refers to the ribs or channels being formed in the substantial continuous wall 105 of the pole.

At the end portion 120 of the base 100, a plurality of support member elements 200 are provided. Each of these support members 200 are preferably slidably engaged and retained by the pole base 110. In this instance, a plurality of discontinuities 450 in the form of channels or recesses are provided at least in the base 110 of the pole 100. In this embodiment, the pole 100 including its base 110 is produced as an extrusion from aluminium. This extrusion provides a number of recesses or channels 450. These recesses or channels are configured to engage the ribs 215 of the support element and thereby retain the support member/elements 200. In this way, the support member 200 for mounting the base 110 to a foundation does not require additional mechanical or chemical fixing to the base.

Engagement of the support member 200 into the recesses 450 can be accomplished in several ways. In one embodiment, the support member 200 is simply slid into the recesses or channels 450 formed in the base 110.

In an alternative embodiment as shown in FIG. 4, arms 210 extending from the support member 200 for engagement with the recesses or channels 450 can be moveable. These arms 210 which are normally biased outwardly can be forced inwardly so as to provide clearance between the ribs 215 and the recesses/channels 450. The support member/element 200 is then placed in position and released such that the arms 210 return to their normal outwardly biased such that the ribs 215 closely engage the recesses/channels 450 in the pole. FIG. 4 shows one support member 200A about to be installed, one support member 200B being installed and one support member 200C in its installed position.

In the embodiment shown, four support elements are provided around the base of the pole to support the pole in four directions. The biasing of the arms 210 and ribs 215 also assists in compensating for manufacturing tolerances in the pole extrusion 100. To explain, as it would be cleared to persons skilled in the art, in a preferred embodiment the pole is made from extruded aluminium. As such, there would be variations in the manufacturing tolerances. It is preferred to have a close contact between the support member/element 200 and the discontinuities or recesses/channels 450 in the pole. Outwardly biasing the arms 210 such that the rubs 215 snuggly fit into the recesses/channels 450 serves to compensate for these manufacturing tolerances.

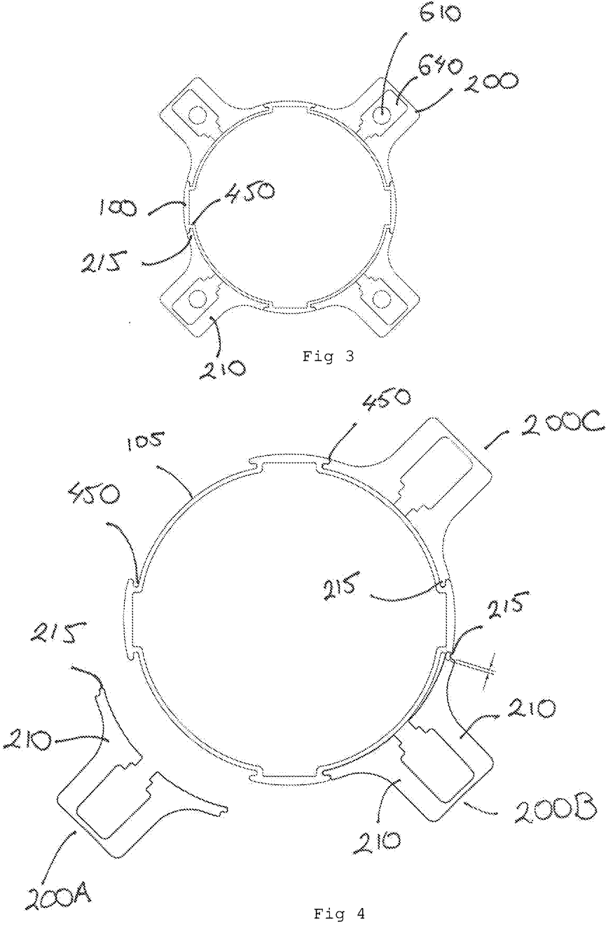

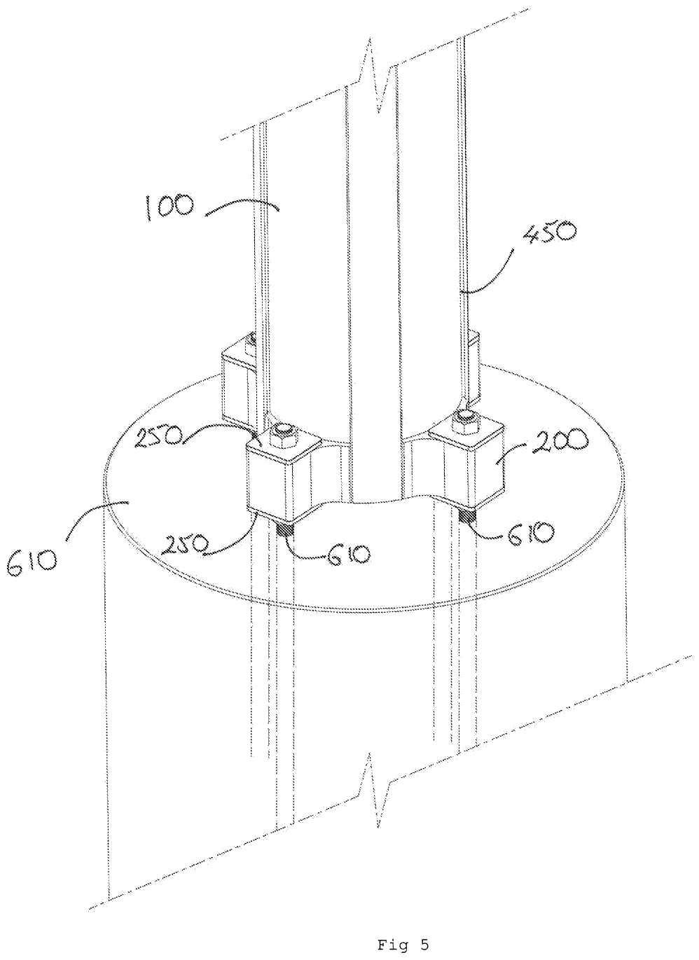

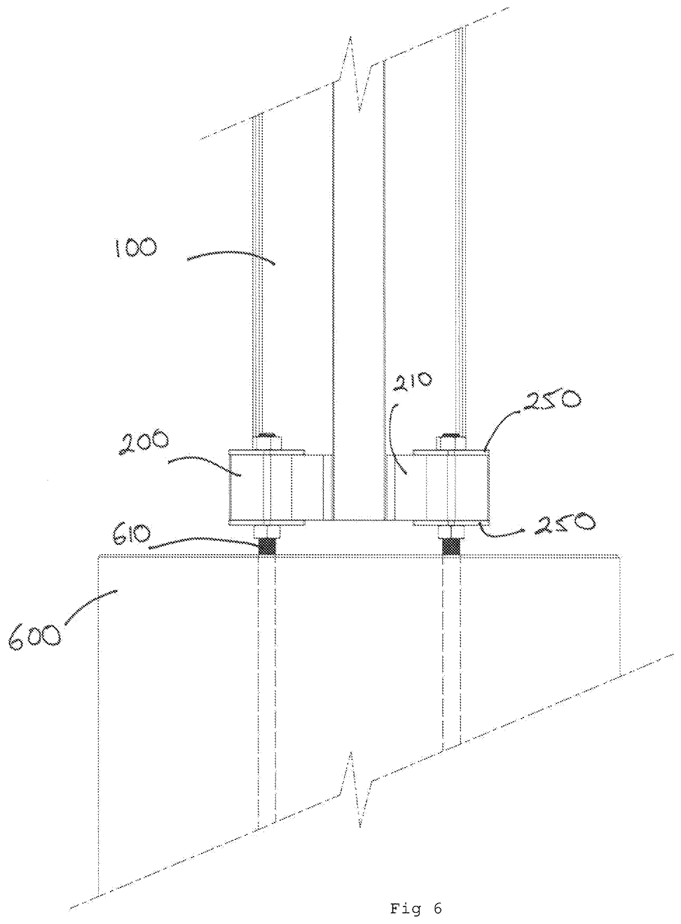

The embodiment shown in FIGS. 3, 5 and 6 will now be explained. When the support members/elements are in position at the base of the pole as shown in FIG. 3, they are preferably connected directly to foundation bolts 610 extending from the foundation 600. To explain, when mounting said poles, a foundation 600 is prepared normally from cast concrete, stone or the like. Foundation bolts 610 are embedded into the foundation as shown in FIGS. 5 and 6. These foundation bolts then engage the support member elements 200 as will be explained.

In the embodiment shown, the foundation bolts 610 are connected to the support elements/members 200 by means of plates 250 (FIG. 5). The foundation bolts 610 essentially pass all the way through the support element 200 and are connected to upper and lower plates 350. In the embodiments shown, and as discussed above, the constant cross section of the support elements/member 200 again provides flexibility. In some cases the foundation bolts 610 may not be precisely in place or at the precise angle needed. In one embodiment of the present invention and as shown more clearly in FIG. 3, an aperture 340 runs through the support member 200 and thereby gives clearance for the foundation bolts 610 to pass therethrough. The upper and lower plates 350 and nuts 620 then connect the support elements/members 200 to the foundation.

It can be seen, that the load applied by the pole 100 is transferred over the entire predetermined length of engagement of the support element 200 with the discontinuities 450 and thereby to the foundation by the foundation bolts. If the load to be applied to the pole and then foundation is relatively high, the predetermined length of the chosen support element in engagement with the pole can simply be increased to spread the load and more reliably support the pole. Equally, if the load which can be expected to be applied to the pole and the foundation is low, for instance if the pole is quite short or light, the support elements chosen can be equally be of reduced predetermined length.

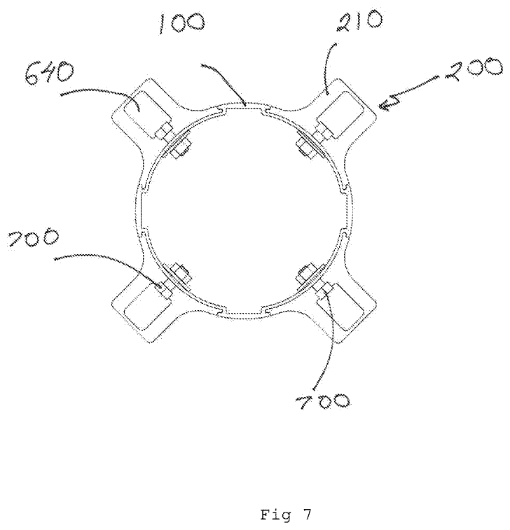

A further embodiment of the present invention shown in FIG. 7. In this embodiment, cam members 700 are provided to further bias the arms 210 of the support member/element 200 and increase contact between ribs 215 in the recesses 450 of the pole. To explain, in this embodiment cam members 700 extend laterally through the base of the pole and engage at least the arms 210 of the support members/elements 200. In this case, the cam members 700 are hex-head bolts. The bolts can be rotated such that they force the arms 210 outwardly and thereby push the ribs 215 towards recesses 450. Of course, other cam members and interior profiles of the support elements/member 200 can be designed to accomplish this technique. For example, vertically oriented cams may also be used. The applicant, however, has found that such hex-head bolts are a cost effective mechanism of providing this function. Additionally, the hex-head bolt assists in maintaining close contact between the support element and the pole. It should be stressed, however, that these bolts do not provide any substantive load bearing function in the inventive device.

Another option to ensure appropriate positioning of the support element/members 200 on the base 100 of the pole is to provide a small amount of chemical fixing eg, gluing once the support element is slidably engaged in the pole.

Indeed, any of the aforementioned processes for biasing by means by its structure and form, chemically fixing by gluing or mechanical biasing by means of a cam member or the like, can be used to assist in providing the desired close, snug fit of the support member on the pole and the ribs 215 into recesses/channels 450.

In the embodiment shown, the base 100 is configured to receive and retain 4 support members 200 equally spaced at 90° interval around the base of the pole 100. Equally, the pole 100 could be extruded with a channel/recess configuration to receive any number of support members 200.

In can be seen from the reliable and cost effective slidable connection of the support members with the pole, the pole will be retained in its substantially vertical configuration by means of the support members.

1. A system for connecting a pole, mast or similar elongated element to a foundation, said pole, mast or similar elongated element having an exterior wall with a plurality of discontinuities disposed about its periphery, said system comprising of plurality of support members adapted to extend between the pole and the foundation, said support members adapted to extend between at least two of said discontinuities and engage said discontinuities over a predetermined axial length, said support members being provided with at least a pair of arms biased toward respective discontinuities.

2. A system as claimed in claim 1 wherein said predetermined axial length is defined in response to the force applied by the pole to the support member for transmission to the foundation.

3. A system as claimed in claim 1, wherein said predetermined axial length is defined in response to the maximum expected force applied by the pole to the support member for transmission to the foundation.

4. A system as claimed in claim 1, wherein the support element comprises a first engagement portion, adapted to engage said discontinuities and a second portion outwardly extending from said first portion for fixing to the foundation.

5. A system as claimed in claim 4 wherein said first portion is adapted to slidably engage said pole.

6. A system as claimed in claim 1, wherein the pole is an aluminium extrusion.

7. A system as claimed in claim 1, wherein said discontinuities are formed as a plurality of recesses or channels adapted to slidably receive with said support members.

8. A system as claimed in claim 1, wherein said support members include arms adapted to engage said recesses or channels.

9. A system as claimed in claim 8 wherein said arms terminate in elongate ribs adapted to slidably engage said recesses or channels.

10. A system as claimed in claim 1, wherein a plurality of support members are provided at regularly spaced intervals around the perimeter of the pole.

11. A system as claimed in claim 1, wherein said support members are chemically and/or mechanically fixed to said pole.

12. (canceled)

13. A system as claimed in claim 1, wherein at least said pair of arms are biased away from one another to thereby, in use, engage mutually opposed respective discontinuities.

14. A system as claimed in claim 1, wherein said discontinuities are configured as longitudinally extending strengthening members or ribs.

15. A system as claimed in claim 1, wherein said support member is constructed from a different material from said pole.

16. A system as claimed in claim 1, wherein said support member is of constant cross section along its length.

17. A system as claimed in claim 1, wherein said support element has an aperture therethrough adapted to facilitate engagement with foundation fixing means.

18. A system as claimed in claim 1, wherein said support members are substantially L shaped with a substantially upright portion adapted to slidably engage said pole, and a base portion adapted to engage the foundation.

19. A system as claimed in claim 1, wherein said predetermined length of said support member engaging said discontinuities is between 200 to 500 millimetres in the axial direction.

20. A system as claimed in claim 1, wherein said predetermined length of said support member engaging said discontinuity is between 250 to 350 millimetres in the axial direction.

21. A system as claimed in claim 1, wherein in addition to said engagement with said discontinuities, said support members are chemically and/or mechanically fixed to said pole.

22. A system as claimed in claim 1, wherein said support members include a cam arrangement for controllably applying a biasing force to the support member to engage said discontinuities.

23. A system as claimed in claim 22 wherein said cam arrangement is provided between said arms for controllably applying a biasing force to outwardly bias said arms to engage said recesses or channels.

24. A system as claimed in claim 1, wherein said support members are adapted to engage a pair of mutually opposed discontinuities.

25. A support element for supporting a pole, a mast or similar elongated element to a foundation, said elongated element having an exterior wall with a plurality of discontinuities disposed about its periphery, said support member having a first engagement portion adapted to span between at least two of said discontinuities and engage said discontinuities over a predetermined axial length, and a second foundation portion outwardly extending from the first portion for fixing to a foundation, wherein said support members are provided with at least a pair of arms biased toward respective discontinuities.

26. A support element as claimed in claim 25 wherein said predetermined axial length is defined in response to the force applied by the pole to the support member for transmission to the foundation.

27. A support element as claimed in claim 25, wherein said predetermined axial length is defined in response to the maximum expected force applied by the pole to the support member for transmission to the foundation.

28. A support element as claimed in claim 25, wherein the support element comprises a first engagement portion, adapted to engage said discontinuities and a second portion outwardly extending from said first portion for fixing to the foundation.

29. A support element as claimed in claim 28 wherein said first portion is adapted to slidably engage said pole.

30. A support element as claimed in claim 25, wherein the pole is an aluminium extrusion.

31. A support element as claimed in claim 25, wherein said discontinuities are formed as a plurality of recesses or channels adapted to slidably receive with said support members.

32. A support element as claimed in claim 25, wherein said support members include arms adapted to engage said recesses or channels.

33. A support element as claimed in claim 32 wherein said arms terminate in elongate ribs adapted to slidably engage said recesses or channels.

34. A support element as claimed in claim 25, wherein a plurality of support members are provided at regularly spaced intervals around the perimeter of the pole.

35. A support element as claimed in claim 25, wherein said support members are chemically and/or mechanically fixed to said pole.

36. (canceled)

37. A support element as claimed in claim 25, wherein said support members are provided with at least a pair of arms biased away from one another to thereby, in use, engage mutually opposed respective discontinuities.

38. A support element as claimed in claim 25, wherein said discontinuities are configured as longitudinally extending strengthening members or ribs.

39. A support element as claimed in claim 25, wherein said support member is constructed from a different material from said pole.

40. A support element as claimed in claim 25, wherein said support member is of constant cross section along its length.

41. A support element as claimed in claim 25, wherein said support element has an aperture therethrough adapted to facilitate engagement with foundation fixing means.

42. A support element as claimed in claim 25, wherein said support members are substantially L shaped with a substantially upright portion adapted to slidably engage said pole, and a base portion adapted to engage the foundation.

43. A support element as claimed in claim 25, wherein said predetermined length of said support member engaging said discontinuities is between 200 to 500 millimetres in the axial direction.

44. A support element as claimed in claim 25, wherein said predetermined length of said support member engaging said discontinuity is between 250 to 350 millimetres in the axial direction.

45. A support element as claimed in claim 25, wherein in addition to said engagement with said discontinuities, said support members are chemically and/or mechanically fixed to said pole.

46. A support element as claimed in claim 25, wherein said support members include a cam arrangement for controllably applying a biasing force to the support member to engage said discontinuities.

47. A support element as claimed in claim 46 wherein said cam arrangement is provided between said arms for controllably applying a biasing force to outwardly bias said arms to engage said recesses or channels.

48. A support element as claimed in claim 25, wherein said support members are adapted to engage a pair of mutually opposed discontinuities.

49. A method of supporting a pole, mast or similar elongated element to a foundation, said pole, mast or similar elongated element having an exterior wall with a plurality of discontinuities disposed about its periphery, said method comprising providing a plurality of support members extending between the pole and the foundation, said support member extending between at least two of said discontinuities and positioned to engage said discontinuities over a predetermined axial length to thereby support said pole and transmit force applied to the pole through the said foundation, wherein said support members are provided with at least a pair of arms biased toward respective discontinuities.

50. A method as claimed in claim 49 wherein said predetermined axial length is defined in response to the force applied by the pole to the support member for transmission to the foundation.

51. A method as claimed in claim 49, wherein said predetermined axial length is defined in response to the maximum expected force applied by the pole to the support member for transmission to the foundation.

52. A method as claimed in claim 49, wherein the support element comprises a first engagement portion, adapted to engage said discontinuities and a second portion outwardly extending from said first portion for fixing to the foundation.

53. A method as claimed in claim 52 wherein said first portion is adapted to slidably engage said pole.

54. A method as claimed in claim 49, wherein the pole is an aluminium extrusion.

55. A method as claimed in claim 49, wherein said discontinuities are formed as a plurality of recesses or channels adapted to slidably receive with said support members.

56. A method as claimed in claim 49, wherein said support members include arms adapted to engage said recesses or channels.

57. A method as claimed in claim 56 wherein said arms terminate in elongate ribs adapted to slidably engage said recesses or channels.

58. A method as claimed in claim 49, wherein a plurality of support members are provided at regularly spaced intervals around the perimeter of the pole.

59. A method as claimed in claim 49, wherein said support members are chemically and/or mechanically fixed to said pole.

60. (canceled)

61. A method as claimed in claim 49, wherein said pair of arms are biased away from one another to thereby, in use, engage mutually opposed respective discontinuities.

62. A method as claimed in claim 49, wherein said discontinuities are configured as longitudinally extending strengthening members or ribs.

63. A method as claimed in claim 49, wherein said support member is constructed from a different material from said pole.

64. A method as claimed in claim 49, wherein said support member is of constant cross section along its length.

65. A method as claimed in claim 49, wherein said support element has an aperture therethrough adapted to facilitate engagement with foundation fixing means.

66. A method as claimed in claim 49, wherein said support members are substantially L shaped with a substantially upright portion adapted to slidably engage said pole, and a base portion adapted to engage the foundation.

67. A method as claimed in claim 49, wherein said predetermined length of said support member engaging said discontinuities is between 200 to 500 millimetres in the axial direction.

68. A method as claimed in claim 49, wherein said predetermined length of said support member engaging said discontinuity is between 250 to 350 millimetres in the axial direction.

69. A method as claimed in claim 49, wherein in addition to said engagement with said discontinuities, said support members are chemically and/or mechanically fixed to said pole.

70. A method as claimed in claim 49, wherein said support members include a cam arrangement for controllably applying a biasing force to the support member to engage said discontinuities.

71. A method as claimed in claim 70 wherein said cam arrangement is provided between said arms for controllably applying a biasing force to outwardly bias said arms to engage said recesses or channels.

72. A method as claimed in claim 49, wherein said support members are adapted to engage a pair of mutually opposed discontinuities.
